(19) United States
(12) Patent Application Publication
(10) Pub. No.: US 2023/0366806 A1
(43) Pub. Date: Nov. 16, 2023

(54) Structure

(71) Applicant: Nippon Telegraph and Telephone Corporation, Tokyo (JP)

(72) Inventors: Shota Oki, Tokyo (JP); Shingo Mineta, Tokyo (JP); Mamoru Mizunuma, Tokyo (JP); Soichi Oka, Tokyo (JP)

(21) Appl. No.: 18/246,996

(22) PCT Filed: Oct. 30, 2020
(86) PCT No.: PCT/JP2020/040795

§ 371 Date: Mar. 28, 2023

(51) Int. Cl. G01N 17/04

(52) U.S. Cl. CPC G01N 17/04

(57) ABSTRACT

A structure includes a base made of a metal such as a steel material, and a reference portion made of a material that is not corroded in a corrosive environment of the metal. The reference portion is embedded in the base such that one end is exposed to form the same plane as a surface of the base. The reference portion is formed in a rod shape extending from the surface of the base toward the inside of the base.

### CROSS-REFERENCE TO RELATED APPLICATIONS

This application is a national phase entry of PCT Application No. PCT/JP2020/040795, filed on Oct. 30, 2020, which application is hereby incorporated herein by reference.

### TECHNICAL FIELD

The present invention relates to a structure composed of a base made of a metal.

### BACKGROUND

When a structure made of a metal is exposed to a natural environment for a long period of time, its thickness decreases due to corrosion. Due to this corrosion phenomenon, deterioration of metal structures progresses, and in the past, serious accidents such as tunnel collapse and bridge collapse have occurred in various countries of the world (Non Patent Literature 1). In the approximately 20 years since the high economic growth period, social infrastructure such as roads, bridges, and dams has been developed in a large amount and rapidly, and thus there is a concern that currently estimated aging equipment will further increase. Metals such as steel materials are used much equipment, and in order to maintain the safety and security of such equipment, it is important to ascertain a deterioration state of the equipment and to perform appropriate maintenance according to the deterioration state.

Currently, as a means for ascertaining a deterioration state of equipment, visual inspection is mainly performed. Since the state is directly checked, it is possible to know the state as it is and to obtain reliable knowledge. However, it is difficult to detect signs of deterioration in some kinds of equipment, and only a skilled technician can make a determination. In recent years, the working population of skilled technicians engaged in inspection has been decreasing, and appropriate inspection work for a large amount of equipment laid across the country is being delayed. In addition, since 50 years have passed since the construction of equipment developed after the high economic growth period, the number of deteriorated equipment to be inspected is also increasing year by year. It is said that it will be difficult to maintain the safety and security of equipment in the near future due to a decrease in the working population of skilled technicians and an increase in deteriorated equipment.

The main cause of deterioration of metal equipment is corrosion. Corrosion is a phenomenon in which the thickness of a metal structure decreases, and it is known that a corrosion reaction proceeds as a series of an oxidation reaction (anode reaction) in which a metal is ionized and a reduction reaction (cathode reaction) in which water, dissolved oxygen, or the like receives electrons. Therefore, inspection of metal equipment mainly focuses on measurement of the amount of thinning of the metal structure, and measuring how much the metal structure has been reduced or scraped from the designed initial thickness.

### CITATION LIST

### Non Patent Literature

Non Patent Literature 1: Y. Wan et al., “Corrosion Behaviors of Q235 Steel in Indoor Soil”, International Journal of Electrochemical Science”, vol. 8, pp. 12531-12542, 2013.

### SUMMARY

### Technical Problem

However, since corrosion generally progresses as overall corrosion in which the entire thickness decreases on average, it is not possible to set a reference surface for measuring the amount of corrosion thinning, and it is often difficult to measure the corrosion. In addition, in the case of local corrosion in which corrosion progresses at an abnormal rate only in a part of the metal structure in a special environment, the amount of corrosion thinning is measured on the basis of a peripheral surface in which no local corrosion occurs. However, in this case, since corrosion thinning progresses due to overall corrosion on the peripheral surface at the same time, the measured amount of corrosion thinning is underestimated, which may lead to an accident in the worst case. In addition, depending on the method of setting the reference surface, the amount of corrosion thinning may vary depending on the inspector, and a uniform inspection may not be executed. As described above, conventionally, there has been a problem that the amount of thinning of a metal structure cannot be accurately measured.

Embodiments of the present invention have been made to solve the above problems, and an object of embodiments of the present invention is to enable accurate measurement of the amount of thinning of a structure made of a metal.

### Solution to Problem

A structure according to embodiments of the present invention includes a base made of a metal, and a reference portion that is made of a material that is not corroded in a corrosive environment of the metal, and is embedded in the base such that one end is exposed to form the same plane as a surface of the base.

### Advantageous Effects of Embodiments of Invention

As described above, according to embodiments of the present invention, since the reference portion made of a material that is not corroded in the corrosive environment of the metal constituting the base is embedded in the base, the amount of thinning of the structure made of the metal can be accurately measured.

### BRIEF DESCRIPTION OF THE DRAWINGS

FIG. 1 is a cross-sectional view illustrating the configuration of a structure according to an embodiment of the present invention.

FIG. 2 is a cross-sectional view illustrating a configuration of a structure according to the embodiment of the present invention.

### DETAILED DESCRIPTION OF ILLUSTRATIVE EMBODIMENTS

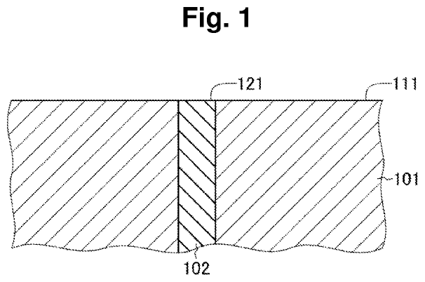

A structure according to an embodiment of the present invention will be described below with reference to FIG. 1. This structure includes a base 101 made of a metal such as a steel material, and a reference portion 102 made of a material that is not corroded in a corrosive environment of the metal. The reference portion 102 is embedded in the base 101 such that one end 121 is exposed to form the same plane as the surface in of the base 101. In addition, the reference portion 102 is formed in a rod shape (columnar shape) extending from the surface in of the base 101 toward the inside of the base 101. The reference portion 102 extends in a direction in which the base 101 is thinned. The length of the reference portion 102 in the extending direction can be the same as the thickness of the base 101 in this direction. In addition, a plurality of reference portions 102 can be embedded in the base 101.

The base 101 is used for a metal structure such as a steel frame used for a building, and can be made of various metals. This type of metal material has high strength required for a building or the like formed as a structure and does not cost much, and generally deteriorates due to oxidation or the like. In addition, the size, shape, thickness, and the like of the base 101 can be arbitrarily determined according to the specifications in a case where the base is used as a structure. The base 101 has a size capable of accommodating the reference portion 102 therein. In addition, it is preferable that the reference portion 102 be embedded in the base 101 so that the structure does not fall below a required set proof stress.

The reference portion 102 can be made of a metal oxide such as silicon oxide or aluminum oxide. Further, the reference portion 102 can be made of glass. Further, the reference portion 102 can be made of, for example, a rock such as marble. In addition, the reference portion 102 can be made of a metal such as gold, platinum, tungsten, titanium, tantalum iridium, or the like. When the reference portion 102 is made of a metal, contact corrosion of dissimilar metals may occur due to contact with the base 101. In this case, it is necessary to take measures such as covering the periphery of the reference portion 102 with an insulator.

The base 101 deteriorates due to corrosion in a natural environment. The deterioration of the base 101 is based on an oxidation-reduction reaction, in which an oxidation reaction (anode reaction) in which a metal is ionized and a reduction reaction (cathode reaction) in which dissolved oxygen or the like receives electrons progress as a series (Non Patent Literature 1). When the base 101 is made of iron, the corrosion reaction is as follows: “Fe→Fe²⁺+2e . . . (1), O₂+2H₂O+4e⁻→4OH⁻ . . . (2).”

The deterioration of a metal (iron) due to corrosion is caused by a decrease in the thickness of the iron base due to ionization of iron represented by Formula (1). Therefore, if it is possible to accurately measure how much the thickness of the base 101 has decreased, it is possible to check whether or not the structure is sound by visual inspection. In addition, by comparing the obtained corrosion thinning data with the number of years since construction of the target equipment, the corrosion rate of the structure (base 101) can be calculated, and it is possible to provide an indication of how many years later the target equipment should be renewed. In addition, if a large amount of measurement results can be prepared, corrosion prediction based on big data analysis becomes possible, and a corrosion map can be created on the basis of a deterioration risk for each construction year or installation environment, leading to creation of a tool useful for equipment management.

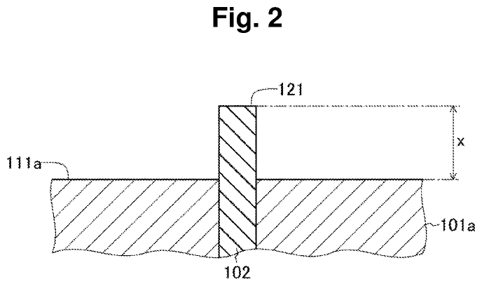

For example, when the structure according to the embodiment is installed in an environment desired to be used, the base 101 is thinned due to corrosion deterioration. As a result, as illustrated in FIG. 2, the reference portion 102 in which corrosion does not occur in this environment protrudes from a surface 111 of a base 101a that has deteriorated due to corrosion. This protruding state can be easily checked visually. By measuring a protruding length x of the reference portion 102, the amount of corrosion thinning of the base iota can be accurately known.

In this manner, the corrosion thinning is determined by measuring the length of the reference portion 102 protruding due to the thinning due to the corrosion deterioration of the base 101. In other words, the reference portion 102 is used as a ruler for measuring the amount of corrosion thinning. Therefore, as described above, it is preferable that the reference portion 102 extend in a direction in which the base 101 is thinned from the surface in of the base 101 toward the inside of the base 101. In addition, by forming a scale of a predetermined unit on the side surface of the reference portion 102 having a rod shape, the length of the protruding portion can be easily measured.

There is a likelihood that a rust layer or a rust hump will be formed on the surface 111a of the base 101a that has deteriorated due to corrosion. In this case, for example, the length of the reference portion 102 protruding from the rust hump may be measured as the amount of thinning. In a case where the rise of the rust hump is large, the measured value x of corrosion thinning will be underestimated, and will fall in a high risk in equipment management. In order to avoid this and measure a more correct corrosion thinning value, it is preferable to remove rust formed on the surface 111a of the base 101a. As a method for removing rust, for example, means such as peeling of rust with a tool or rust removal using a high power laser can be used.

As described above, by measuring the length of the reference portion 102 protruding due to corrosion deterioration of the base 101 due to long-term use of the structure, corrosion thinning is determined. Therefore, it is preferable that the reference portion 102 have a certain degree of strength so that the portion where the reference portion 102 protrudes is not broken by external stress. From such a viewpoint, for example, when the diameter of the rod-shaped reference portion 102 is too small, it is easily conceivable that the protruding portion is broken by an external force as described above. Therefore, it is desirable to pay attention to the structure and configuration of the reference portion 102 from the viewpoint of strength.

In addition, it is important to reliably bond the base 101 and the reference portion 102 so that the reference portion 102 does not come off the base 101. In addition, if there is a gap between the base 101 and the reference portion 102, special deterioration due to corrosion generated at this portion progresses, and therefore adhesion between the base 101 and the reference portion 102 is reliably performed also from this viewpoint. In addition, when the reference portion 102 is colored, it is easier to visually check, and therefore the reference portion 102 can be appropriately colored according to the need of the user.

As described above, according to embodiments of the present invention, since the reference portion made of a material that is not corroded in the corrosive environment of the metal constituting the base is embedded in the base, the amount of thinning of the structure due to the metal can be accurately measured.

Note that the present invention is not limited to the embodiment described above, and it is obvious that many modifications and combinations can be implemented by a person having ordinary knowledge in the art within the technical idea of the present invention.

### REFERENCE SIGNS LIST

101 Base
102 Reference portion
111 Surface
121 One end.

1-5. (canceled)

6. A structure comprising:
a base made of a metal; and
a reference portion that is made of a material that does not corrode in a corrosive environment of the metal, the reference portion being embedded in the base such that a first end of the reference portion is exposed to form a same plane as a surface of the base.

7. The structure according to claim 6, wherein the reference portion has a rod shape extending from the surface of the base toward an inside of the base.

8. The structure according to claim 7, wherein the reference portion extends in a direction in which the base thins from corrosion.

9. The structure according to claim 6, wherein the reference portion is made of a metal oxide.

10. The structure according to claim 6, wherein the reference portion is made of glass.

11. A structure comprising:
a metal base; and
a reference portion embedded in the metal base, the reference portion being exposed at a surface of the metal base, and the reference portion being made of a first material is less susceptible to corrosion than a second material of the metal base, wherein the reference portion is configured to provide a reference for an amount the metal base thins as a result of corrosion.

12. The structure according to claim 11, wherein the reference portion is made of a metal oxide.

13. The structure according to claim 11, wherein the reference portion is made of glass.

14. A method for determining a corrosion amount, the method comprising:
embedding a reference portion in a base made of a metal, wherein the reference portion is made of a material that does not corrode in a corrosive environment of the metal, and the reference portion being embedded in the base such that a first end of the reference portion is exposed to form a same plane as a surface of the base; and
determining a corrosion amount of the base by measuring an amount that the reference portion protrudes from the surface of the base.

15. The method according to claim 14, wherein the reference portion is made of a metal oxide.

16. The method according to claim 14, wherein the reference portion is made of glass.
